(19) United States
(12) Patent Application Publication
(10) Pub. No.: US 2026/0349083 A1
(43) Pub. Date: Nov. 5, 2026

(54) LIDAR AND VEHICLE

(71) Applicant: AUTOX TECH PTE. LTD., SINGAPORE (SG)

(72) Inventors: Puxi Hu, Shenzhen (CN); Yanan Zhi, Shenzhen (CN); Jianxiong Xiao, Shenzhen (CN); Yizhou Shan, Shenzhen (CN); Xuhui Tao, Shenzhen (CN); Xi Zou, Shenzhen (CN); Zhenkun Wang, Shenzhen (CN); Xin Wang, Shenzhen (CN)

(73) Assignee: AUTOX TECH PTE. LTD., SINGAPORE (SG)

(21) Appl. No.: 19/194,007

(22) Filed: Apr. 30, 2025

(51) Int. Cl. G01S 7/481; G01S 17/88

(52) U.S. Cl. CPC G01S 7/4817; G01S 7/4811; G01S 17/88

(57) ABSTRACT

The disclosure provides a LiDAR comprising a main module and a plurality of scanning modules, the main module being communicatively coupled to each of the scanning modules, and arranged on a first plane; wherein the main module comprises a laser transceiver assembly configured to emit laser light that is sequentially enters one of the plurality of scanning modules; each scanning module includes a window, through which the laser light reflected by the scanning module is emitted to form a detection field of view; combined detection fields of view of the scanning modules provide full 360° coverage in the first plane. Further, a vehicle using the LiDAR is also provided.

### TECHNICAL FIELD

The disclosure relates to the technical field of LiDAR, and particularly to a LiDAR and a vehicle.

### BACKGROUND

Nowadays, typical representatives of automotive Frequency Modulated Continuous Wave (FMCW) hybrid solid-state LiDAR include Innovusion LiDAR and Luminar LiDAR, featuring a field of view (FOV) of 120°×25° and a maximum angular resolution of 0.06°×0.06° in the staring region. Existing implementations achieve two-dimensional scanning for hybrid solid-state LiDAR systems through a one-dimensional rotating polygonal prism scanning in one axis and a one-dimensional rotating scanning optical device operating in the orthogonal axis. While this scanning methodology enables specific FOV coverage in both vertical and horizontal directions, the rotating polygonal prism utilized for horizontal scanning inherently creates substantial blind zones. In practical deployment scenarios, as FMCW radars are forward-mounted and their horizontal FOV is universally constrained below 135°, they fail to detect the vehicle's lateral flanks and rear fields of view, resulting in undetected blind zones that pose significant safety risks for high-level autonomous vehicles.

### SUMMARY

In view of the above, it is indeed necessary to provide a LiDAR and a vehicle that can achieve a larger horizontal field of view, thereby reducing the blind spots of the vehicle.

In a first aspect, the embodiment of the disclosure provides a LiDAR, a main module and a plurality of scanning modules, the main module being communicatively coupled to each of the scanning modules, and arranged on a first plane; wherein the main module comprises a laser transceiver assembly configured to emit laser light that is sequentially enters one of the plurality of scanning modules; each scanning module includes a window, through which the laser light reflected by the scanning module is emitted to form a detection field of view; combined detection fields of view of the scanning modules provide full 360° coverage in the first plane. Further, a vehicle using the LiDAR is also provided.

In a second aspect, the embodiment of the disclosure provides a vehicle, which includes a vehicle body and the LiDAR as described above. The LiDAR is mounted on the vehicle body.

In the above-mentioned LiDAR and vehicle, the LiDAR includes a main unit module and a plurality of scanning modules that are separately arranged. Each scanning module has a detection field of view. Through the joint coverage of the detection fields of view of all the scanning modules, the detection field of view of the LiDAR is formed. Among them, the horizontal field of view angle of the detection field of view can reach 360°, and the vertical field of view angle of the detection field of view can reach 25°, so that the field of view range of the detection field of view of the LiDAR reaches 360°×25°, having the characteristics of distributed arrangement and large field of view. When applied in the field of autonomous driving, the LiDAR is mounted on the vehicle and can detect a range of 360° around the vehicle, so that the vehicle has no blind spots, thereby increasing the safety factor of autonomous driving.

### BRIEF DESCRIPTION OF THE DRAWINGS

For a clearer description of the technical solutions in the embodiments of the disclosure or the prior art, a brief introduction to the drawings used in the description of the embodiments or the prior art will be provided below. It is apparent that the drawings described below are merely some embodiments of the disclosure, and those skilled in the art may derive other drawings based on the structures shown in these drawings without creative efforts.

FIG. 1 is a top view of a LiDAR in accordance with an embodiment.

FIG. 2 is an exploded view of the LiDAR in accordance with an embodiment.

FIG. 3 is an internal structural view of the LiDAR in accordance with an embodiment.

FIG. 4 is an internal view of the main module of the LiDAR shown in FIG. 1.

FIG. 5 is a first internal view of the scanning module of the LiDAR shown in FIG. 1.

FIG. 6 is a second internal view of the scanning module of the LiDAR shown in FIG. 1.

FIG. 7 is a schematic view of a vehicle in accordance with an embodiment.

The realization of the objectives, technical features, and advantages of the disclosure will be further described below with reference to the embodiments, the drawings, and the implementation modes.

### DETAILED DESCRIPTION OF THE EMBODIMENTS

In order to make the purpose, technical solution, and advantages of disclosure clearer and clearer, the following will provide further detailed explanations of disclosure in conjunction with the accompanying drawings and embodiments. It should be understood that the specific embodiments described here are only intended to explain the disclosure and are not intended to limit the disclosure. Based on the embodiments in disclosure, all other embodiments obtained by ordinary technical personnel in this field without creative labor fall within the scope of protection of disclosure.

The terms “first,” “second,” “third,” “fourth,” etc. (if present) in the specification, claims, and accompanying drawings of the disclosure are used to distinguish similar planning objects and are not necessarily used to describe a specific sequence or order. It should be understood that such terms, when used, may be interchangeable under appropriate circumstances. In other words, the described embodiments may be implemented in an order other than that illustrated or described herein. Furthermore, the terms “include” and “have” and any variations thereof may also encompass additional content. For example, a process, method, system, product, or device comprising a series of steps or units is not limited to only those steps or units clearly listed but may include other steps or units not clearly listed or inherent to those processes, methods, products, or device.

It is understood that the descriptions involving “first,” “second,” etc., in the disclosure are solely for descriptive purpos and should not be understood as indicating or implying their relative importance or implicitly specifying the number of indicated technical features. Therefore, features qualified by “first,” “second,” etc., may explicitly or implicitly include one or more of such features. In addition, the technical solutions among the various embodiments may be combined with each other, but this must be based on the ability of ordinary skilled artisans in the field to achieve such combinations. When the combination of technical solutions contradicts each other or cannot be implemented, such combinations should be deemed non-existent and not within the scope of protection claimed in the disclosure.

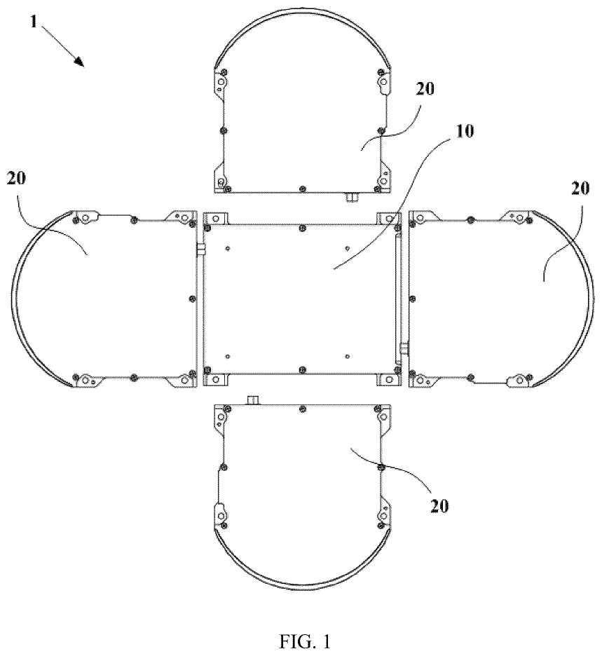

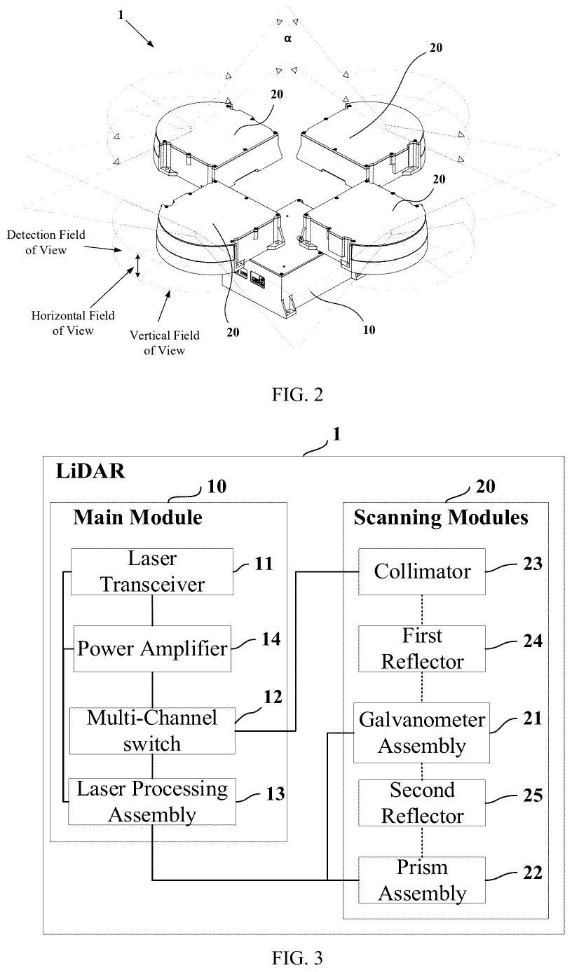

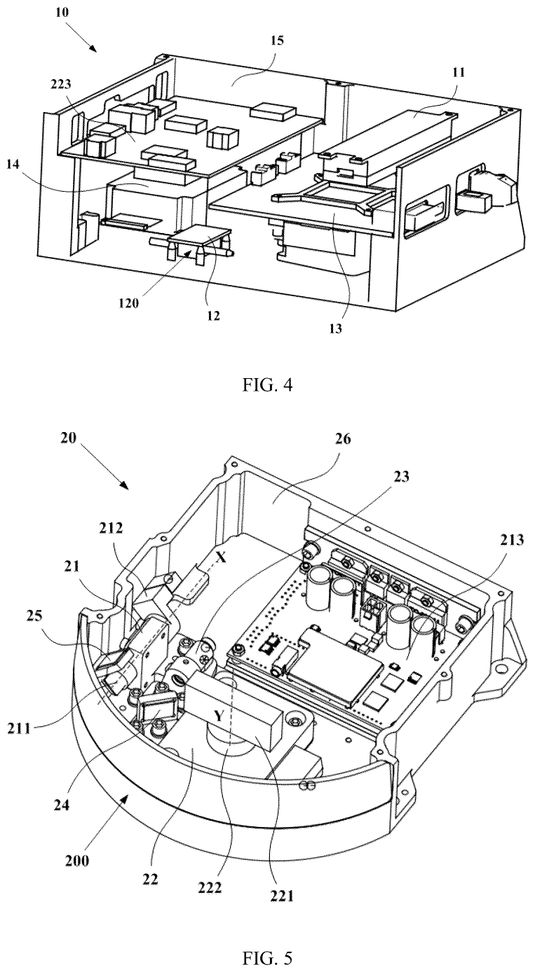

Referring to FIGS. 1, 2, 3, and 4, FIG. 1 is a top view of a LiDAR in accordance with an embodiment, FIG. 2 is an exploded view of the LiDAR in accordance with an embodiment, FIG. 3 is an internal structural view of the LiDAR in accordance with an embodiment, and FIG. 4 is an internal view of the main module of the LiDAR shown in FIG. 1. The LiDAR 1 is a hybrid solid-state LiDAR applied in the field of autonomous driving for detecting the surrounding environment of autonomous vehicles. In some feasible embodiments, the LiDAR 1 may also be applied in fields such as intelligent robots and industrial applications.

The LiDAR 1 includes a main module 10, and a plurality of scanning modules 20, the main module 10 is electrically connected to each scanning module 20. The main module 10 and the scanning modules 20 are coupled via optical fibers. The specific number of scanning modules 20 may be set according to actual detection requirements and is not limited here.

The main module 10 includes a main housing 15, a laser transceiver assembly 11, a multi-channel switch 12, a laser processing assembly 13, and a power amplifier 14. The laser transceiver assembly 11, the multi-channel switch 12, the laser processing assembly 13, and the power amplifier 14 are all disposed within the main housing 15.

In this embodiment, the laser processing assembly 13 is electrically connected to the laser transceiver assembly 11, the multi-channel switch 12, and the power amplifier 14 respectively, the power amplifier 14 is electrically connected to the laser transceiver assembly 11 and the multi-channel switch 12 respectively, and the multi-channel switch 12 is electrically connected to each scanning module 20 respectively. It can be understood that the multi-channel switch 12 is electrically connected to the laser transceiver assembly 11 via the power amplifier 14. The laser processing assembly 13 is configured to provide control signals to the laser transceiver assembly 11, the multi-channel switch 12, and the power amplifier 14, and receive corresponding feedback signals.

The laser processing assembly 13 is configured to control the laser transceiver assembly 11 to emit laser light, the laser light emitted by the laser transceiver assembly 11 sequentially entering each of the plurality of scanning modules 20. Specifically, the multi-channel switch 12 is configured to sequentially transmit the laser light emitted by the laser transceiver assembly 11 to each of the plurality of scanning modules 20. In this embodiment, the multi-channel switch 12 includes a plurality of channels 120 corresponding one-to-one to the scanning modules 20, the laser processing assembly 13 being further configured to sequentially activate one of the plurality of channels 120. It can be understood that the number of scanning modules 20 is the same as the number of channels 120, and the corresponding scanning modules 20 and channels 120 are connected. The main module 10 activates only one channel at a time, transmitting laser light to only one corresponding scanning module 20, and the main module 10 sequentially transmits laser light to the scanning modules 20 in a certain order. For example, if the number of scanning modules 20 and the number of channels 120 are both n, each scanning module 20 and each channel 120 are connected one-to-one. When the laser processing assembly 13 activates the m-th channel 120, the laser light correspondingly enters the m-th scanning module 20. In this embodiment, when the main module 10 activates all channels 120 in the multi-channel switch 12 once, i.e., each scanning module 20 receives laser light once, the LiDAR 1 completes one scan detection. After completing one scan detection, the LiDAR 1 continues to perform the next scan detection.

After the laser light enters the scanning module 20, it passes through the optical path system in the scanning module 20 and exits the scanning module 20. The laser light emitted from the scanning module 20 is reflected by an object to form an echo, the echo being received by the laser transceiver assembly 11 after reflection by the corresponding scanning module 20. That is, the scanning module 20 that emits the laser light and the scanning module 20 that receives the corresponding echo are the same scanning module 20.

The laser transceiver assembly 11 is further configured to process the laser light and the echo to obtain electrical signals and transmit the electrical signals to the laser processing assembly 13. Specifically, the laser transceiver assembly 11 forms electrical signals based on the interference of the laser light and the echo. The laser processing assembly 13 is further configured to receive the electrical signals transmitted by the laser transceiver assembly 11 and form point cloud data of the object based on the electrical signals. Specifically, the laser processing assembly 13 processes and images the electrical signals to form point cloud data of the object.

In this embodiment, the laser processing assembly 13 controls the laser transceiver assembly 11 to emit laser light, the laser light emitted by the laser transceiver assembly 11 being amplified by the power amplifier 14 and then entering the multi-channel switch 12. The laser processing assembly 13 controls the multi-channel switch 12 to emit the laser light from one of the channels 120, the emitted laser light reaching the corresponding scanning module 20 via an optical fiber.

In this embodiment, the laser transceiver assembly 11 comprises a laser source, an optical beam splitter, an optical circulator, an optical bridge, and a photodiode balanced detector. The laser source is electrically connected to the laser processing assembly 13 and the optical beam splitter respectively, the optical beam splitter is electrically connected to the optical circulator and the optical bridge respectively, the optical bridge is electrically connected to the optical circulator and the photodiode balanced detector respectively, the photodiode balanced detector is electrically connected to the laser processing assembly 13, and the optical circulator is electrically connected to the power amplifier 14.

Specifically, the laser processing assembly 13 controls the laser source to generate laser light, the laser light being transmitted to the power amplifier 14 via the optical beam splitter and the optical circulator. The echo transmitted by the scanning module 20 enters the power amplifier 14 via the corresponding channel 120, then enters the optical bridge via the optical circulator, the laser light and the echo interfere in the optical bridge to generate corresponding electrical signals, the electrical signals being transmitted to the laser processing assembly 13 via the photodiode balanced detector. The optical beam splitter is a 1*2 optical beam splitter, and the laser source is a Frequency Modulated Continuous Wave (FMCW) laser source. That is, the laser light emitted by the laser transceiver assembly 11 is frequency-modulated continuous wave, and correspondingly, the LiDAR 1 is an FMCW LiDAR. In this embodiment, the laser light is a 1550 nm band beam.

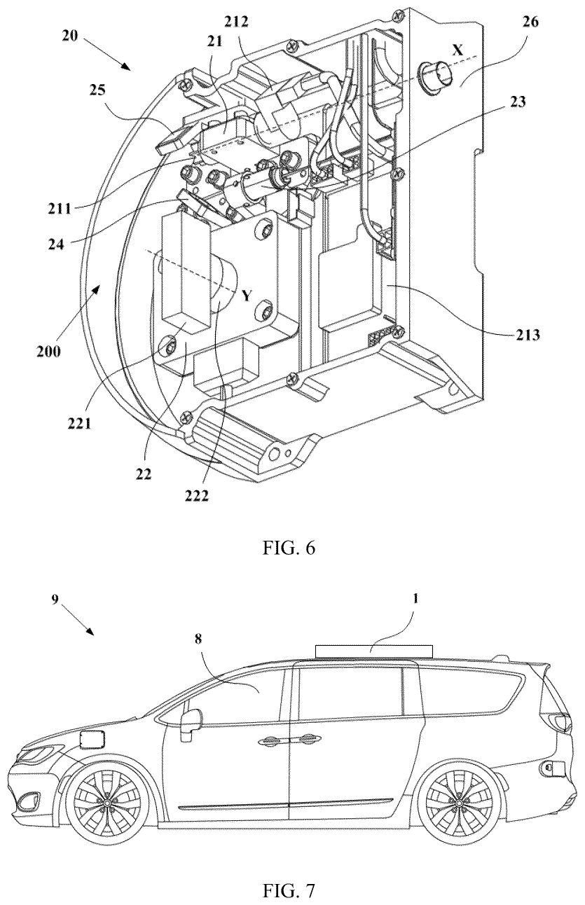

Referring to FIGS. 5 and 6, FIGS. 5 and 6 are internal views of the scanning module of the LiDAR in accordance with an embodiment. In this embodiment, the plurality of scanning modules 20 are disposed on a first plane. Specifically, the plurality of scanning modules 20 are centered around the main module 10 and spaced apart therefrom. Preferably, the plurality of scanning modules 20 are rotationally symmetric about a midpoint of the main module 10. It can be understood that all scanning modules 20 are located on the first plane. When transmitting laser light, the main module 10 may transmit the laser light to the scanning modules 20 in a clockwise order or a counterclockwise order. In this embodiment, the main module 10 is also located on the first plane. In some feasible embodiments, the main module 10 may be located on other planes, which is not limited here. Taking the LiDAR 1 shown in FIG. 1 as an example, the LiDAR 1 comprises four scanning modules 20, the four scanning modules 20 and the main module 10 all being located on the first plane. The four scanning modules 20 are respectively disposed on four sides of the main module 10, and the four scanning modules 20 are rotationally symmetric about the midpoint of the main module 10. The rotation angle is 90°.

The LiDAR 1 is distributed as a whole, i.e., the main module 10 and each scanning module 20 are independent and separate devices. The scanning module 20 comprises a scanning housing 26. In this embodiment, the scanning housing 26 of the scanning module 20 and the main housing 15 of the main module 10 are separated into independent housings, i.e., the scanning housings 26 are not connected to each other or to the main housing 15. In some feasible embodiments, the scanning housing 26 may be connected to a side wall of the main housing 15, so that the main module 10 and the scanning modules 20 may form an integral whole.

In this embodiment, the scanning housing 26 is provided with a window 200, the window 200 being located on a side of the scanning module 20 facing away from the main module 10. The laser light is emitted from the window 200 through reflection by the scanning module 20 to form a detection field of view, the detection fields of view of the plurality of scanning modules 20 collectively covering up to 360° within the first plane. It can be understood that each scanning module 20 has a detection field of view, and the detection fields of view of all scanning modules 20 overlap and collectively form the detection field of view of the LiDAR 1, enabling the LiDAR 1 to have a larger detection field of view. When the LiDAR 1 is installed on a vehicle, it can effectively reduce vehicle blind zones.

The scanning module 20 comprises a galvanometer assembly 21 and a prism assembly 22. In this embodiment, the galvanometer assembly 21 comprises a galvanometer mirror 211, a galvanometer motor 212, and a galvanometer control board 213, the galvanometer control board 213 being electrically connected to the galvanometer motor 212, the galvanometer mirror 211 being disposed on the galvanometer motor 212, the galvanometer motor 212 being configured to drive the galvanometer mirror 211 to oscillate. The prism assembly 22 comprises a prism 221, a prism motor 222, and a prism control board 223, the prism control board 223 being electrically connected to the prism motor 222, the prism 221 being disposed on the prism motor 222, the prism motor 222 being configured to drive the prism 221 to rotate. The galvanometer mirror 211, the galvanometer motor 212, the prism 221, and the prism motor 222 are all disposed within the scanning housing 26. The galvanometer control board 213 and the prism control board 223 are both circuit boards, and the galvanometer control board 213 and the prism control board 223 are respectively provided with a plurality of electronic components for controlling the galvanometer motor 212 and the prism motor 222 respectively.

Specifically, the galvanometer motor 212 drives the galvanometer mirror 211 to oscillate reciprocally about a first axis X within a predetermined angular range, the prism motor 222 drives the prism 221 to rotate about a second axis Y. The first axis X is parallel to the first plane, and the second axis Y is perpendicular to the first plane. It can be understood that the first axis X and the second axis Y are perpendicular. In this embodiment, the predetermined angular range is +6.25° to −6.25°, the prism motor 222 drives the prism 221 to perform a 360° rotational scanning motion about the second axis Y. Preferably, the prism 221 is a dual-sided prism. In some feasible embodiments, the predetermined angular range may be set according to actual detection requirements and is not limited here.

The laser processing assembly 13 is electrically connected to the galvanometer control board 213 and the prism control board 223 respectively, the laser processing assembly 13 being further configured to control the galvanometer control board 213 to transmit drive signals to the galvanometer motor 212 and control the prism control board 223 to transmit drive signals to the prism motor 222. In this embodiment, the galvanometer control board 213 is disposed in the scanning module 20, and the prism control board 223 is disposed in the main module 10. In some feasible embodiments, the galvanometer control board 213 or the prism control board 223 may be disposed in the scanning module 20 or the main module 10, or both the galvanometer control board 213 and the prism control board 223 may be disposed in the scanning module 20 or the main module 10, which is not limited here.

In this embodiment, the prism 221 is disposed opposite to the window 200. The laser light emitted by the laser transceiver assembly 11 is incident on the galvanometer mirror 211, reflected by the galvanometer mirror 211, and then incident on the prism 221, the laser light being emitted from the window 200 through reflection by the prism 221. The laser light reflected by the galvanometer mirror 211 is all located in a second plane, the second axis Y being located within the second plane. It can be understood that the second plane is perpendicular to the first plane. The laser light is all incident on the prism 221 along the second plane.

The detection field of view of each scanning module 20 comprises a horizontal field of view and a vertical field of view. The vertical field of view is formed by the laser light reflected by the galvanometer mirror 211, and the horizontal field of view is formed by the laser light reflected by the prism 221. In this embodiment, since the oscillation range of the galvanometer mirror 211 is +6.25° to −6.25°, the vertical field of view formed by the reflection of the galvanometer mirror 211 has an angle of 25°. That is, the size of the predetermined angular range determines the size of the vertical field of view angle, and adjusting the size of the predetermined angular range can adjust the size of the vertical field of view angle. Therefore, the size of the vertical field of view angle is not limited thereto. Taking the number of scanning modules 20 being three as an example, if the horizontal field of view angle of each scanning module 20 is 140°, the overlapping angle α of the horizontal fields of view between two adjacent scanning modules 20 is 20°, and the horizontal fields of view of the three scanning modules 20 collectively achieve a horizontal field of view angle of 360° for the detection field of view of the LiDAR 1. That is, the detection field of view of the LiDAR 1 has a horizontal field of view angle of 360° and a vertical field of view angle of 25°.

The scanning module 20 further comprises a collimator 23, a first reflector 24, and a second reflector 25, the collimator 23, the first reflector 24, and the second reflector 25 all being disposed within the scanning housing 26. The collimator 23 is connected to the multi-channel switch 12, each channel 120 being connected to the collimator 23 of a corresponding scanning module 20. The collimator 23 is disposed opposite to the first reflector 24, the galvanometer mirror 211 being disposed on a reflection optical path of the first reflector 24, the first reflector 24 being configured to reflect the laser light emitted by the collimator 23 to the galvanometer mirror 211. The second reflector 25 is disposed on a reflection optical path of the galvanometer mirror 211, the prism 221 being disposed on a reflection optical path of the second reflector 25, the second reflector 25 being configured to reflect the laser light reflected by the galvanometer mirror 211 to the prism 221.

Specifically, the reflection surfaces of the galvanometer mirror 211, the prism 221, the first reflector 24, and the second reflector 25 are all coated with a reflective film, and the reflectivity of the galvanometer mirror 211, the prism 221, the first reflector 24, and the second reflector 25 to 1550 nm laser light is all greater than 90%.

In this embodiment, the collimator 23 is disposed in a direction parallel to the first axis X, the laser light reflected by the first reflector 24 is incident on the galvanometer mirror 211 in a direction perpendicular to the first axis X. The laser light reflected by the galvanometer mirror 211 is substantially incident on the second reflector 25 in a direction parallel to the second axis Y, the laser light reflected by the second reflector 25 is substantially incident on the prism 221 in a direction perpendicular to the second axis Y. Specifically, the collimator 23 and the first reflector 24 are disposed between the galvanometer mirror 211 and the prism 221, the galvanometer mirror 211 being adjacent to the collimator 23, the first reflector 24 and the second reflector 25 being located in the second plane. The collimator 23, the first reflector 24, the galvanometer mirror 211, the second reflector 25, and the prism 221 are compactly disposed, which can effectively reduce the volume of the scanning module 20, enabling the LiDAR 1 to have the advantage of miniaturization as a whole.

The laser light entering the scanning module 20 reaches the collimator 23, is reflected by the first reflector 24, and is incident on the galvanometer mirror 211. The laser processing assembly 13 controls the galvanometer control board 213 to generate drive signals for the galvanometer motor 212, causing the galvanometer mirror 211 to oscillate about the first axis X, thereby forming the vertical field of view. The laser light is then reflected by the second reflector 25 and is incident on the prism 221. The laser processing assembly 13 controls the prism control board 223 to generate drive signals for the prism motor 222, causing the prism 221 to perform a 360° rotational scanning motion about the second axis Y, thereby forming the horizontal field of view. The laser light emitted from the window is incident on an object to form an echo, the echo being reflected along the original path, passing through the optical path system of the corresponding scanning module 20, and reaching the laser transceiver assembly 11.

In the above embodiments, the LiDAR comprises a main module and a plurality of scanning modules that are separately disposed, each scanning module having a detection field of view, the detection fields of view of all scanning modules collectively covering to form the detection field of view of the LiDAR. The horizontal field of view angle of the detection field of view can reach 360°, and the vertical field of view angle of the detection field of view can reach 25°, enabling the detection field of view of the LiDAR to have a field of view range of 360°×25°, featuring a distributed and large field of view. When applied in the field of autonomous driving, the LiDAR is installed on a vehicle and can detect the 360° surroundings of the vehicle, eliminating blind zones and increasing the safety factor of autonomous driving.

In addition, the LiDAR is a hybrid solid-state LiDAR, having advantages such as small moment of inertia, simple structure, high reliability, and easy integration and miniaturization, and has good development prospects in the field of automotive LiDAR.

Referring to FIG. 7, a schematic view of a vehicle in accordance with an embodiment is illustrated. The vehicle 9 comprises a vehicle body 8 and the LiDAR 1. The specific structure of the LiDAR 1 refers to the above embodiments.

In this embodiment, the LiDAR 1 is disposed on the vehicle body 8. Preferably, the LiDAR 1 is installed on the roof of the vehicle body 8, so that the LiDAR 1 can detect not only the front of the vehicle 9 but also the left and right sides and the rear of the vehicle 1. That is, the LiDAR 1 can detect the 360° surroundings of the vehicle 9, thereby avoiding blind zones, increasing the safety factor of the vehicle 1, and improving the safety of the vehicle 1 during driving. In some feasible embodiments, the installation position of the LiDAR 1 on the vehicle body 8 may be set according to actual detection requirements and is not limited here.

Since the vehicle 9 adopts all the technical solutions of the above embodiments, the vehicle 9 at least has all the beneficial effects brought by the technical solutions of the above embodiments, which will not be repeated here.

It is apparent to those skilled in the art that various modifications and variations can be made to the disclosure without departing from the spirit and scope thereof. Therefore, if these modifications and variations of the disclosure fall within the scope of the claims of the disclosure and their equivalents, the disclosure also intends to cover these modifications and variations.

The above-listed are merely preferred embodiments of the disclosure and cannot be used to limit the scope of the claims of the disclosure. Therefore, equivalent variations made according to the claims of the disclosure still fall within the scope covered by the disclosure.

1. A LiDAR, comprising:
a main module, and
a plurality of scanning modules, the main module being communicatively coupled to each of the scanning modules, and arranged on a first plane;
wherein the main module comprises a laser transceiver assembly configured to emit laser light that is sequentially enters one of the plurality of scanning modules;
each scanning module includes a window, through which the laser light reflected by the scanning module is emitted to form a detection field of view;
combined detection fields of view of the scanning modules provide full 360° coverage in the first plane.

2. The LiDAR according to claim 1, wherein the plurality of scanning modules are symmetrically arranged around the main module and spaced apart from each other, t window of each scanning module is positioned on a side facing away from the main module, the main module further comprises a multi-channel switch, the multi-channel switch is electrically connected to the laser transceiver assembly and each of the scanning modules respectively, the multi-channel switch is configured to route the laser light emitted by the laser transceiver assembly to one of the plurality of scanning modules at a time.

3. The LiDAR according to claim 2, wherein the plurality of scanning modules are arranged in a rotationally symmetric pattern about a central axis of the main module, with equal angular spacing between adjacent modules.

4. The LiDAR according to claim 2, wherein each scanning module comprises
a galvanometer assembly, including a galvanometer mirror, and a galvanometer motor configured to drive the galvanometer mirror to oscillate; and
a prism assembly, including a prism, and a prism motor configured to drive the prism to rotate;
wherein the laser light emitted by the laser transceiver assembly is reflected by the galvanometer mirror, and then reflected by the prism, finally exits through the window of the the scanning modules.

5. The LiDAR according to claim 4, wherein the galvanometer motor drives the galvanometer mirror to oscillate bidirectionally about a first axis within a predetermined angular range, the prism motor drives the prism to rotate about a second axis, the first axis is parallel to the first plane, the second axis is perpendicular to the first plane; all laser light reflected by the galvanometer mirror is located in a second plane, the second axis is located within the second plane; the detection field of view comprises a horizontal field of view and a vertical field of view, the vertical field of view is formed by the laser light reflected by the galvanometer mirror, the horizontal field of view is formed by the laser light reflected by the prism.

6. The LiDAR according to claim 4, wherein each scanning module further comprises:
a collimator, optically coupled to the multi-channel switch;
a first reflector, opposite to the collimator, the galvanometer mirror being disposed on a reflection optical path of the first reflector, the first reflector being configured to reflect the laser light emitted by the collimator to the galvanometer mirror,
a second reflector, disposed on a reflection optical path of the galvanometer mirror, the prism being disposed on a reflection optical path of the second reflector, the prism being disposed opposite to the window; the second reflector being configured to reflect the laser light reflected by the galvanometer mirror to the prism.

7. The LiDAR according to claim 6, wherein the multi-channel switch comprises a plurality of channels corresponding one-to-one to the scanning modules, each channel is optically connected to the collimator of a corresponding scanning module; the main module further comprises a laser processing assembly electrically connected to the multi-channel switch, the laser processing assembly is configured to sequentially activate one of the plurality of channels.

8. The LiDAR according to claim 7, wherein the laser light exiting the window is reflected by a target object to form a echo, the echo is received by the laser transceiver assembly after reflection by the corresponding scanning module, the laser transceiver assembly is further configured to process the laser light and the echo to obtain electrical signals; the laser processing assembly is electrically connected to the laser transceiver assembly, and further configured to control the laser transceiver assembly to emit laser light, receive the electrical signals transmitted by the laser transceiver assembly, and form point cloud data of the object based on the electrical signals.

9. The LiDAR according to claim 7, wherein the galvanometer assembly further comprises a galvanometer control board electrically connected to the galvanometer motor, the prism assembly further comprises a prism control board electrically connected to the prism motor; the laser processing assembly is electrically connected to the galvanometer control board and the prism control board respectively, the laser processing assembly is further configured to control the galvanometer control board to transmit drive signals to the galvanometer motor, and control the prism control board to transmit drive signals to the prism motor.

10. A vehicle, comprising:
a vehicle body; and
a LiDAR, comprising:
a main module, and
a plurality of scanning modules, the main module being communicatively coupled to each of the scanning modules, and arranged on a first plane;
wherein the main module comprises a laser transceiver assembly configured to emit laser light that is sequentially enters one of the plurality of scanning modules;
each scanning module includes a window, through which the laser light reflected by the scanning module is emitted to form a detection field of view;
combined detection fields of view of the scanning modules provide full 360° coverage in the first plane.

11. The vehicle according to claim 10, wherein the plurality of scanning modules are symmetrically arranged around the main module and spaced apart from each other, the window of each scanning module is positioned on a side facing away from the main module, the main module further comprises a multi-channel switch, the multi-channel switch is electrically connected to the laser transceiver assembly and each of the scanning modules respectively, the multi-channel switch is configured to route the laser light emitted by the laser transceiver assembly to one of the plurality of scanning modules at a time.

12. The vehicle according to claim 11, wherein the plurality of scanning modules are arranged in a rotationally symmetric pattern about a central axis of the main module, with equal angular spacing between adjacent modules.

13. The vehicle according to claim 11, wherein each scanning module comprises
a galvanometer assembly, including a galvanometer mirror, and a galvanometer motor configured to drive the galvanometer mirror to oscillate; and
a prism assembly, including a prism, and a prism motor configured to drive the prism to rotate;
wherein the laser light emitted by the laser transceiver assembly is reflected by the galvanometer mirror, and then reflected by the prism, finally exits through the window of the the scanning modules.

14. The vehicle according to claim 13, wherein the galvanometer motor drives the galvanometer mirror to oscillate bidirectionally about a first axis within a predetermined angular range, the prism motor drives the prism to rotate about a second axis, the first axis is parallel to the first plane, the second axis is perpendicular to the first plane; all laser light reflected by the galvanometer mirror is located in a second plane, the second axis is located within the second plane; the detection field of view comprises a horizontal field of view and a vertical field of view, the vertical field of view is formed by the laser light reflected by the galvanometer mirror, the horizontal field of view is formed by the laser light reflected by the prism.

15. The vehicle according to claim 13, wherein each scanning module further comprises:
a collimator, optically coupled to the multi-channel switch;
a first reflector, opposite to the collimator, the galvanometer mirror being disposed on a reflection optical path of the first reflector, the first reflector being configured to reflect the laser light emitted by the collimator to the galvanometer mirror,
a second reflector, disposed on a reflection optical path of the galvanometer mirror, the prism being disposed on a reflection optical path of the second reflector, the prism being disposed opposite to the window; the second reflector being configured to reflect the laser light reflected by the galvanometer mirror to the prism.

16. The vehicle according to claim 15, wherein the multi-channel switch comprises a plurality of channels corresponding one-to-one to the scanning modules, each channel is optically connected to the collimator of a corresponding scanning module; the main module further comprises a laser processing assembly electrically connected to the multi-channel switch, the laser processing assembly is configured to sequentially activate one of the plurality of channels.

17. The vehicle according to claim 16, wherein the laser light exiting the window is reflected by a target object to form a echo, the echo is received by the laser transceiver assembly after reflection by the corresponding scanning module, the laser transceiver assembly is further configured to process the laser light and the echo to obtain electrical signals; the laser processing assembly is electrically connected to the laser transceiver assembly, and further configured to control the laser transceiver assembly to emit laser light, receive the electrical signals transmitted by the laser transceiver assembly, and form point cloud data of the object based on the electrical signals.

18. The vehicle according to claim 17, wherein the galvanometer assembly further comprises a galvanometer control board electrically connected to the galvanometer motor, the prism assembly further comprises a prism control board electrically connected to the prism motor; the laser processing assembly is electrically connected to the galvanometer control board and the prism control board respectively, the laser processing assembly is further configured to control the galvanometer control board to transmit drive signals to the galvanometer motor, and control the prism control board to transmit drive signals to the prism motor.

19. A LiDAR, comprising:
a main module, and
a plurality of scanning modules, distributed around and communicatively coupled to the main module;
wherein the main module comprises a laser transceiver assembly configured to emit laser light sequentially directed to each of the scanning modules;
each scanning module includes a window to exist the laser light emission; and
combined detection fields of view of the scanning modules provide full 360°.

20. The LiDAR according to claim 19, wherein the plurality of scanning modules are symmetrically arranged around the main module and spaced apart from each other, the window of each scanning module is positioned on a side facing away from the main module, the main module further comprises a multi-channel switch, the multi-channel switch is electrically connected to the laser transceiver assembly and each of the scanning modules respectively, the multi-channel switch is configured to route the laser light emitted by the laser transceiver assembly to one of the plurality of scanning modules at a time.
